(19) United States
(12) Patent Application Publication
(10) Pub. No.: US 2024/0284544 A1
(43) Pub. Date: Aug. 22, 2024

(54) TECHNIQUES FOR CONFIGURING AND TRIGGERING ENHANCED MEASUREMENTS IN AN IDLE OR INACTIVE STATE

(71) Applicant: QUALCOMM Incorporated, San Diego, CA (US)

(72) Inventors: Hyunwoo CHO, San Diego, CA (US); Changhwan PARK, San Diego, CA (US); Carlos CABRERA MERCADER, Cardiff, CA (US)

(21) Appl. No.: 18/427,352

(22) Filed: Jan. 30, 2024

Related U.S. Application Data
(60) Provisional application No. 63/485,475, filed on Feb. 16, 2023.

(51) Int. Cl. H04W 76/27; H04W 24/08

(52) U.S. Cl. CPC H04W 76/27; H04W 24/08

(57) ABSTRACT

Methods, systems, and devices for wireless communication are described. A user equipment (UE) may receive an indication of a measurement configuration that includes information associated with one or more target frequencies in a first frequency range, such as Frequency Range 2 (FR2). The UE may perform measurements of the one or more target frequencies in the first frequency range in accordance with the measurement configuration while the UE is in an idle or inactive state. The UE may transition from the idle or inactive state to a connected state based on performing a random access procedure with a network entity. Accordingly, the UE may transmit an indication of a measurement report associated with the measurements of the one or more target frequencies in the first frequency range based on transitioning from the idle or inactive state to the connected state.

### CROSS REFERENCE

The present Application for Patent claims priority to U.S. provisional Patent Application No. 63/485,475 by CHO et al., entitled “TECHNIQUES FOR CONFIGURING AND TRIGGERING ENHANCED MEASUREMENTS IN AN IDLE OR INACTIVE STATE,” filed Feb. 16, 2023, which is assigned to the assignee hereof and expressly incorporated by reference herein.

### FIELD OF TECHNOLOGY

The following relates to wireless communication, including techniques for configuring and triggering enhanced measurements in an idle or inactive state.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may perform cell measurements in an idle or inactive mode. When the UE returns to a connected mode, the UE may report the cell measurements to the network. In some cases, however, the cell measurements may be outdated by the time they reach the network.

### SUMMARY

The described techniques relate to improved methods, systems, devices, and apparatuses that support techniques for configuring and triggering enhanced measurements in an idle or inactive state. For example, the described techniques provide for receiving an indication of an enhanced measurement configuration that includes information associated with one or more target frequencies in a first frequency range, performing measurements of the one or more target frequencies in the first frequency range in accordance with the enhanced measurement configuration while in an idle or inactive state, and transmitting an indication of a measurement report associated with the measurements of the one or more target frequencies in the first frequency range based on transitioning from the idle or inactive state to a connected state.

### BRIEF DESCRIPTION OF THE DRAWINGS

FIGS. 1 and 2 illustrate examples of wireless communications systems that support techniques for configuring and triggering enhanced measurements in an idle or inactive state according to one or more aspects of the present disclosure.

FIGS. 3 and 4 illustrate examples of communication timelines that support techniques for configuring and triggering enhanced measurements in an idle or inactive state according to one or more aspects of the present disclosure.

FIG. 5 illustrates an example of a resource diagram that supports techniques for configuring and triggering enhanced measurements in an idle or inactive state according to one or more aspects of the present disclosure.

FIGS. 6 and 7 illustrate examples of communication timelines that support techniques for configuring and triggering enhanced measurements in an idle or inactive state according to one or more aspects of the present disclosure.

FIG. 8 illustrates an example of a process flow that supports techniques for configuring and triggering enhanced measurements in an idle or inactive state according to one or more aspects of the present disclosure.

FIGS. 9 and 10 illustrate block diagrams of devices that support techniques for configuring and triggering enhanced measurements in an idle or inactive state according to one or more aspects of the present disclosure.

FIG. 11 illustrates a block diagram of a communications manager that supports techniques for configuring and triggering enhanced measurements in an idle or inactive state according to one or more aspects of the present disclosure.

FIG. 12 illustrates a diagram of a system including a device that supports techniques for configuring and triggering enhanced measurements in an idle or inactive state according to one or more aspects of the present disclosure.

FIGS. 13 and 14 illustrate block diagrams of devices that support techniques for configuring and triggering enhanced measurements in an idle or inactive state according to one or more aspects of the present disclosure.

FIG. 15 illustrates a block diagram of a communications manager that supports techniques for configuring and triggering enhanced measurements in an idle or inactive state according to one or more aspects of the present disclosure.

FIG. 16 illustrates a diagram of a system including a device that supports techniques for configuring and triggering enhanced measurements in an idle or inactive state according to one or more aspects of the present disclosure.

FIGS. 17 through 20 illustrate flowcharts showing methods that support techniques for configuring and triggering enhanced measurements in an idle or inactive state according to one or more aspects of the present disclosure.

### DETAILED DESCRIPTION

In some wireless communications systems, a user equipment (UE) may transition between different Radio Resource Control (RRC) states, such as an RRC connected state, an RRC idle state, and an RRC inactive state. While the UE is in an idle or inactive state, the UE may perform cell measurements for the purpose of cell reselection, early measurement (EMR), and device mobility, among other examples. After the UE transitions back to a connected state (e.g., by performing a random access procedure), the UE may report the cell measurements back to the network. In some cases, however, if there is a delay between when the cell measurements are performed and reported, the cell measurements may be inaccurate or outdated by the time they reach the network.

If, for example, the UE supports carrier aggregation (CA) or dual connectivity (DC), the cell measurements may be used to set up a secondary cell (SCell) or secondary cell group (SCG) for the UE. However, if these cell measurements are stale or outdated, the UE may perform additional measurements to set up CA or DC, or both, in frequency range 2 (FR2), which includes frequencies between 24 gigahertz (GHz) and 71 GHz. The UE may perform these additional measurements during an RRC resume and/or setup phase, which may be initiated by a mobile-originated (MO) or mobile-terminated (MT) call. However, without additional information from the network, the UE may perform cell search and/or selection to identify and measure candidate SCells and SCGs in FR2, resulting in greater power consumption, higher latency, and lower efficiency.

To improve the efficiency of SCell setup or SCG setup, or both for CA or DC, or both, in FR2, the network may provide the UE with a measurement configuration to use for FR2 enhanced measurements during an RRC setup phase. The measurement configuration may indicate candidate FR2 target frequencies for CA and/or DC, cell identifiers (IDs) for each target frequency, and/or synchronization signal block (SSB) resource locations (e.g., time-domain SSB positions) for each target frequency. In some examples, if the UE is in an RRC connected state, the network may provide the measurement configuration via a unicast message (e.g., an RRC reconfiguration message). In other examples, if the UE is in an RRC idle or inactive state, the network may provide the measurement configuration via a broadcast message, such as a system information block (SIB).

While the UE is in an idle or inactive state, FR2 enhanced measurements may be triggered by an MO call (e.g., a UE-initiated measurement trigger) or an MT call (e.g., a network-initiated measurement trigger). For MO-based FR2 enhanced measurements, the network may provide the UE with an indication of an MO data volume threshold, above which the UE may initiate FR2 enhanced measurements. For MT-based FR2 enhanced measurements, the network may trigger FR2 enhanced measurements via a paging message. In some examples, the network may trigger FR2 enhanced measurements (e.g., via an MT call) based on traffic demand or data volume. After performing the FR2 enhanced measurements in accordance with the measurement configuration provided by the network, the UE may report the FR2 enhanced measurements back to the network.

Aspects of the present disclosure may be implemented to realize one or more of the following advantages. The techniques described herein may improve the efficiency of IDLE measurements or INACTIVE measurements, or both, and reduce the delay associated with setting up an SCell and/or SCG for CA and/or DC in FR2. More specifically, providing the UE with a measurement configuration to use for FR2 enhanced measurements in an IDLE and/or INACTIVE mode (e.g., RRC idle mode/RRC inactive mode) may reduce the amount of time and power the UE spends on cell search and selection, which may enable the UE to identify and measure candidate SCells and/or SCGs with reduced latency and greater efficiency.

If traffic demand is relatively low (e.g., below a data volume threshold), the UE may refrain from performing FR2 enhanced measurements, and the network may refrain from initiating CA and/or DC setup, resulting in greater power savings at both the UE and the network. For example, if the UE performs and reports FR2 enhanced measurements but the network determines not to initiate CA and/or DC setup (e.g., due to traffic demand), the UE may cause the additional power consumption associated with the CA and/or DC setup process. Thus, defining a data threshold may be beneficial for both the UE and the network. The UE may save power by selectively performing FR2 enhanced measurements when traffic demand is relatively low (e.g., below a threshold).

Aspects of the disclosure are initially described in the context of wireless communications systems, communication timelines, resource diagrams, and process flows. Aspects of the disclosure are further illustrated by and described with reference to apparatus diagrams, system diagrams, and flowcharts that relate to techniques for configuring and triggering enhanced measurements in an idle or inactive state.

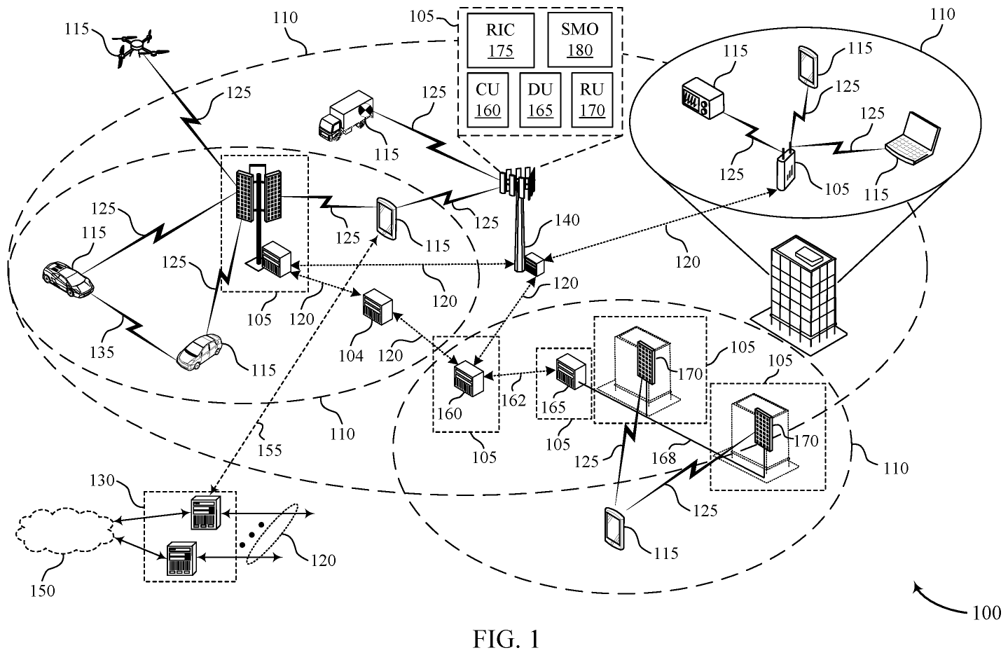

FIG. 1 illustrates an example of a wireless communications system 100 that supports techniques for configuring and triggering enhanced measurements in an idle or inactive state according to one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120).

IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for configuring and triggering enhanced measurements in an idle or inactive state as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 GHz. Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In accordance with the techniques described herein, a UE 115 may receive an indication of a measurement configuration to use for FR2 enhanced measurements. The measurement configuration may indicate parameters (e.g., cell IDs, SSB locations) associated with one or more target frequencies in FR2. Thereafter, when the UE 115 is in an RRC idle or inactive state, the UE 115 may perform measurements of the one or more target frequencies in accordance with the measurement configuration. In some examples, the UE 115 may perform the measurements in response to an MO and/or MT call. Accordingly, the UE 115 may transmit a measurement report associated with the measurements of the one or more target frequencies to the network after transitioning from the RRC idle or inactive mode to an RRC connected mode.

Aspects of the wireless communications system 100 may be implemented to realize one or more of the following advantages. The techniques described with reference to FIG. 1 may improve the efficiency of IDLE/INACTIVE measurements and reduce the delay associated with setting up an SCell/SCG for CA/DC in FR2. More specifically, providing a UE 115 with a measurement configuration to use for FR2 enhanced measurements in an IDLE/INACTIVE mode may reduce the amount of time and power the UE 115 spends on cell search and selection, which may enable the UE 115 to identify and measure candidate SCells/SCGs with reduced latency and greater efficiency. Also, if traffic demand is relatively low (e.g., below a data volume threshold), the UE 115 may refrain from performing FR2 enhanced measurements, thereby avoiding extraneous power consumption and/or processing overhead.

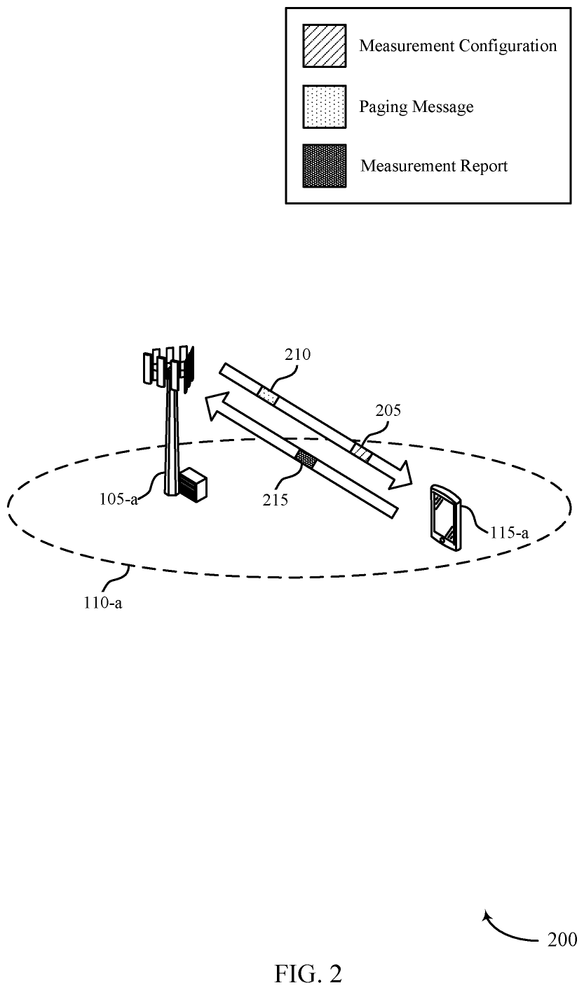

FIG. 2 illustrates an example of a wireless communications system 200 that supports techniques for configuring and triggering enhanced measurements in an idle or inactive state according to one or more aspects of the present disclosure. The wireless communications system 200 may implement or be implemented by aspects of wireless communications system 100. For example, the wireless communications system 200 includes a UE 115-a and a network entity 105-a, which may be examples of corresponding devices described with reference to FIG. 1. The UE 115-a and the network entity 105-a may communicate within a coverage area 110-a, which may be an example of a coverage area 110, as described with reference to FIG. 1. In the example of FIG. 2, the network entity 105-a may provide the UE 115-a with a measurement configuration 205 to use for FR2 enhanced measurements in an idle or inactive state.

As described herein, the UE 115-a may transition between a connected state (e.g., an RRC CONNECTED mode), an idle state (e.g., an RRC IDLE mode), and an inactive state (e.g., an RRC INACTIVE mode). While the UE 115-a is in an idle or inactive state, the UE 115-a may perform cell measurements for the purpose of cell reselection, EMR, and device mobility, among other examples. Thereafter, when the UE 115-a transitions back to a connected state (e.g., after performing a random access procedure with the network entity 105-a), the UE may provide the cell measurements to the network entity in the form of a measurement report 215. In some cases, however, if there is a delay between when the cell measurements are performed and reported, the cell measurements may be inaccurate or outdated by the time they reach the network entity 105-a.

If, for example, the UE 115-a supports CA/DC, the cell measurements may be used to set up and/or configure an SCell or SCG for CA/DC in FR2. However, if the cell measurements are stale or outdated, the UE 115-a may have to perform additional measurements for the purpose of setting up CA/DC in FR2. The UE 115-a may perform these additional measurements during an RRC resume and/or setup phase, which may be initiated by an MO or MT call. However, without additional information from the network entity 105-a, the UE 115-a may have to perform cell search and/or selection to identify and measure candidate SCells and SCGs in FR2, resulting in greater power consumption, higher latency, and lower efficiency.

Aspects of the wireless communications system 200 may support techniques for configuring and triggering FR2 enhanced measurements in an RRC IDLE/INACTIVE state for SCell/SCG setup. To improve the efficiency of SCell/SCG setup for CA/DC in FR2, the network entity 105-a may provide the UE 115-a with a measurement configuration 205 to use for FR2 enhanced measurements during an RRC setup phase. The measurement configuration 205 may indicate candidate FR2 target frequencies for CA/DC, cell ID(s) for each target frequency, and SSB resource locations (e.g., time-domain SSB positions) for each target frequency. In some examples, if the UE 115-a is in an RRC CONNECTED state, the network entity 105-a may provide the measurement configuration 205 to the UE 115-a via a unicast message (e.g., an RRC reconfiguration message). In other examples, if the UE 115-a is in an RRC IDLE/INACTIVE state, the network entity 105-a may provide the measurement configuration 205 via a broadcast message, such as a SIB.

While the UE 115-a is in an RRC IDLE/INACTIVE state, FR2 enhanced measurements may be triggered by an MO call (e.g., a UE-initiated measurement trigger) or an MT call (e.g., a network-initiated measurement trigger). For MO-based FR2 enhanced measurements, the network entity 105-a may provide the UE 115-a with an indication of an MO data volume threshold, above which the UE 115-a may automatically initiate FR2 enhanced measurements. For MT-based FR2 enhanced measurements, the network entity 105-a may trigger FR2 enhanced measurements via a paging message 210. In some examples, the network entity 105-a may trigger FR2 enhanced measurements via an MT call based on traffic demand or data volume. After performing the FR2 enhanced measurements in accordance with the measurement configuration 205, the UE 115-a may transmit a measurement report 215 associated with the FR2 enhanced measurements to the network entity 105-a.

Aspects of the wireless communications system 200 may be implemented to realize one or more of the following advantages. The techniques described with reference to FIG. 2 may improve the efficiency of IDLE/INACTIVE measurements at the UE 115-a and reduce the delay associated with setting up an SCell/SCG for CA/DC in FR2. More specifically, providing the UE 115-a with a measurement configuration 205 to use for FR2 enhanced measurements in an IDLE/INACTIVE mode may reduce the amount of time and power the UE 115-a spends on cell search and selection, which may enable the UE 115-a to identify and measure candidate SCells/SCGs with reduced latency and greater efficiency. Also, if traffic demand is relatively low (e.g., below a data volume threshold), the UE 115-a may refrain from performing FR2 enhanced measurements, resulting in greater power savings at the UE 115-a.

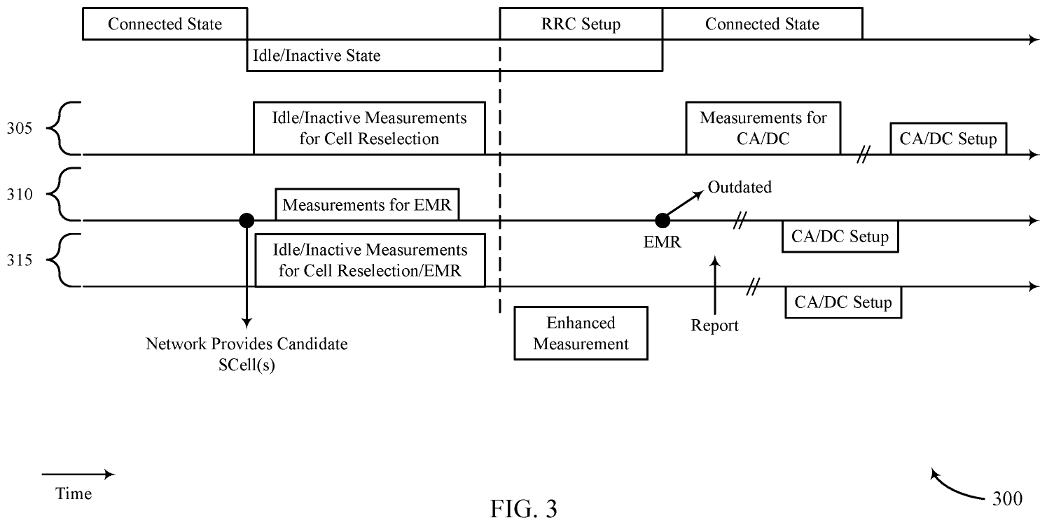

FIG. 3 illustrates an example of a communication timeline 300 that supports techniques for configuring and triggering enhanced measurements in an idle or inactive state according to one or more aspects of the present disclosure. The communication timeline 300 may implement or be implemented by aspects of the wireless communications system 100 or the wireless communications system 200. For example, the communication timeline 300 may be implemented by a UE 115 or a network entity 105, as described with reference to FIGS. 1 and 2. The communication timeline 300 illustrates various RRC state transitions, measurement periods, and CA/DC setup operations for various communication schemes, such as a non-EMR communication scheme 305, an EMR communication scheme 310, and a communication scheme 315 associated with enhanced measurement for UE mobility.

The communication timeline 300 may support measurements during IDLE/INACTIVE state for CA/DC. In some FR2 mobility scenarios, measurements performed during RRC IDLE/INACTIVE may become outdated due to beam characteristics when there is a time gap between when the measurements are performed and reported. To set up an SCG/SCell after transitioning to a connected state, a UE may perform and report measurements again for EMR and non-EMR. In some deployments, the UE may measure candidate target cells for CA/DC setup during an RRC setup period to mitigate measurement accuracy issues in mobility scenarios. The UE may reuse the measurement results from IDLE/INACTIVE state during the enhanced measurement process.

In accordance with aspects of the present disclosure, the UE may receive an indication of a measurement configuration to use for FR2 enhanced measurements. The measurement configuration may indicate parameters (e.g., cell IDs, SSB locations) associated with one or more target frequencies in FR2. Thereafter, when the UE is in an RRC idle or inactive state, the UE may perform measurements of the one or more target frequencies in accordance with the measurement configuration. In some examples, an MO/MT call may trigger the FR2 enhanced measurements. Accordingly, the UE may transmit a measurement report associated with the measurements of the one or more target frequencies in FR2. The UE may transmit the measurement report to the network after transitioning from the RRC idle or inactive mode to an RRC connected mode.

Aspects of the communication timeline 300 may be implemented to realize one or more of the following advantages. The techniques described with reference to FIG. 3 may improve the efficiency of IDLE/INACTIVE measurements and reduce the delay associated with setting up an SCell/SCG for CA/DC in FR2. More specifically, providing a UE with a measurement configuration to use for FR2 enhanced measurements in an IDLE/INACTIVE mode may reduce the amount of time and power the UE spends on cell search and selection, which may enable the UE to identify and measure candidate SCells/SCGs with reduced latency and greater efficiency. Also, if traffic demand is relatively low (e.g., below a data volume threshold), the UE may refrain from performing FR2 enhanced measurements, thereby avoiding extraneous power consumption and/or processing overhead.

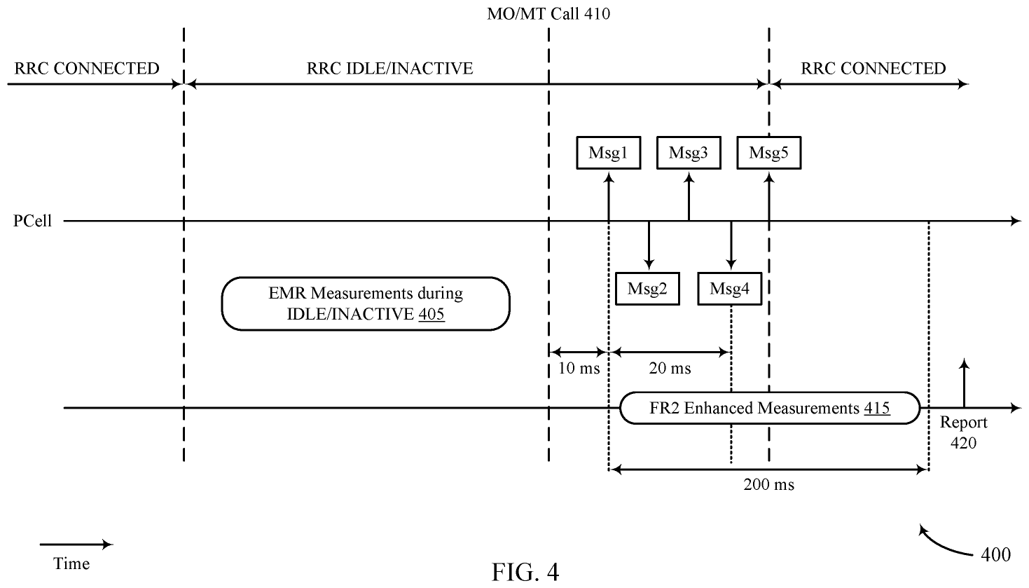

FIG. 4 illustrates an example of a communication timeline 400 that supports techniques for configuring and triggering enhanced measurements in an idle or inactive state according to one or more aspects of the present disclosure. The communication timeline 400 may implement or be implemented by aspects of the wireless communications system 100 or the wireless communications system 200. For example, the communication timeline 300 may be implemented by a UE 115 or a network entity 105, as described with reference to FIGS. 1 and 2. The communication timeline 400 illustrates various RRC state transitions, measurement periods, and random access operations associated with an enhanced measurement scheme. In the example of FIG. 4, a UE with CA/DC capabilities may perform FR2 enhanced measurements 415 (e.g., measurements of target cells/frequencies in FR2) and transmit a measurement report 420 associated with the FR2 enhanced measurements 415.

In some wireless communications systems, a UE may start performing measurements for FR2 CA/DC during RRC resume or setup in mobility. An MO/MT call 410 may initiate RRC resume or setup via a random access channel (RACH) procedure. In some examples, the UE may perform FR2 enhanced measurements 415 after transmitting a first message (Msg1) of a RACH procedure. The UE may continue performing the FR2 enhanced measurements 415 in an RRC CONNECTED state (e.g., if needed). In some implementations, the FR2 enhanced measurements 415 may have a baseline (e.g., minimum) duration of 200 ms. EMR may not be a prerequisite for the FR2 enhanced measurements 415, as the FR2 enhanced measurements 415 may be independent from other measurements 405 performed during RRC IDLE/INACTIVE. The FR2 enhanced measurements 415 may, in some examples, be confined to FR1+FR2 (CA/DC). In some cases, however, the UE may not have sufficient information to perform the FR2 enhanced measurements 415. Moreover, the UE may be unable to determine which conditions (e.g., criteria) trigger the FR2 enhanced measurements 415.

In accordance with aspects of the present disclosure, the UE may receive an indication of a measurement configuration to use for the FR2 enhanced measurements 415. The measurement configuration may indicate parameters (e.g., cell IDs, SSB locations) associated with one or more target frequencies in FR2. Thereafter, when the UE is in an RRC idle or inactive state, the UE may perform measurements of the one or more target frequencies in accordance with the measurement configuration. In some examples, the MO/MT call 410 may trigger the FR2 enhanced measurements 415. Accordingly, the UE may transmit a measurement report 420 associated with the FR2 enhanced measurements 415 of the one or more target frequencies. The UE may transmit the measurement report 420 to the network after transitioning from the RRC idle or inactive mode to an RRC connected mode.

Aspects of the communication timeline 400 may be implemented to realize one or more of the following advantages. The techniques described with reference to FIG. 4 may improve the efficiency of IDLE/INACTIVE measurements and reduce the delay associated with setting up an SCell/SCG for CA/DC in FR2. More specifically, providing a UE with a measurement configuration to use for FR2 enhanced measurements 415 in an IDLE/INACTIVE mode may reduce the amount of time and power the UE spends on cell search and selection, which may enable the UE to identify and measure candidate SCells/SCGs with reduced latency and greater efficiency. Also, if traffic demand is relatively low (e.g., below a data volume threshold), the UE may refrain from performing FR2 enhanced measurements 415, thereby avoiding extraneous power consumption and/or processing overhead.

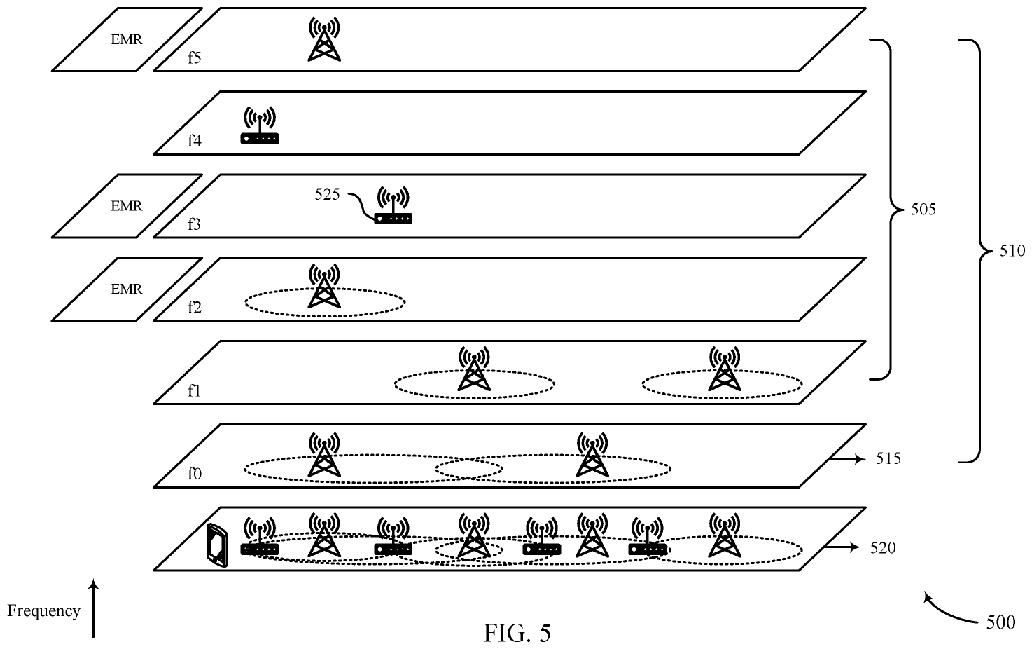

FIG. 5 illustrates an example of a resource diagram 500 that supports techniques for configuring and triggering enhanced measurements in an idle or inactive state according to one or more aspects of the present disclosure. The resource diagram 500 may implement or be implemented by aspects of the wireless communications system 100 or the wireless communications system 200. For example, the communication timeline 300 may include an FR2 cell 525, which may be an example of an SCell or an SCG that a UE 115 sets up and uses for CA/DC. The resource diagram 500 includes a deployment layer 520, which includes all devices and operating frequencies (f₀, f₁, f₂, f₃, f₄, and f₅) of a wireless communications system. The resource diagram 500 also includes inter-frequency layers 505, a decomposed view 510 with respect to frequency layer, and an intra-frequency layer 515.

A primary cell (PCell) may be capable of determining which FR2 cell 525 to use for CA/DC setup, including when both FR1 and FR2 cells are using the same backhaul system. A UE may search all possible FR2 cells, but not all FR2 cells detected by the UE may be used for CA/DC. Geographically, the network may be capable of determining which FR2 cells are candidate CA/DC cells in mobility scenarios. In the example of FIG. 5, the deployment layer 520 may include all deployment frequency layers (f₀, f₁, f₂, f₃, f₄, and f₅), where f₀ is the frequency layer of a camped call (e.g., a cell on which the UE is camping), f₁ is a lower priority frequency, f₂ is an equal priority frequency associated with EMR, f₃ is a higher priority frequency associated with EMR, f₄ is a higher priority frequency, and f₅ is a non-mobility measurement frequency associated with EMR.

In accordance with aspects of the present disclosure, the UE may receive an indication of a measurement configuration to use for FR2 enhanced measurements. The measurement configuration may indicate parameters (e.g., cell IDs, SSB locations) associated with one or more target frequencies in FR2. Thereafter, when the UE is in an RRC idle or inactive state, the UE may perform measurements of the one or more target frequencies in accordance with the measurement configuration. In some examples, an MO/MT call may trigger the FR2 enhanced measurements. Accordingly, the UE may transmit a measurement report associated with the measurements of the one or more target frequencies. The UE may transmit the measurement report to the network after transitioning from the RRC idle or inactive mode to an RRC connected mode.

Aspects of the resource diagram 500 may be implemented to realize one or more of the following advantages. The techniques described with reference to FIG. 5 may improve the efficiency of IDLE/INACTIVE measurements and reduce the delay associated with setting up an SCell/SCG (such as the FR2 cell 525) for CA/DC in FR2. More specifically, providing a UE with a measurement configuration to use for FR2 enhanced measurements in an IDLE/INACTIVE mode may reduce the amount of time and power the UE spends on cell search and selection, which may enable the UE to identify and measure candidate SCells/SCGs with reduced latency and greater efficiency. Also, if traffic demand is relatively low (e.g., below a data volume threshold), the UE may refrain from performing FR2 enhanced measurements, thereby avoiding extraneous power consumption and/or processing overhead.

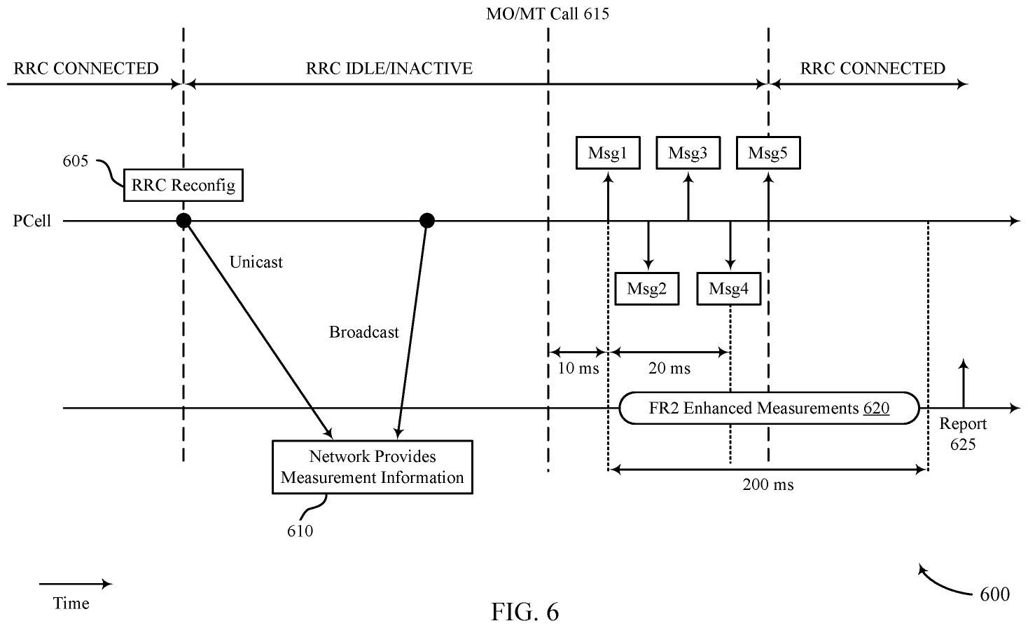

FIG. 6 illustrates an example of a communication timeline 600 that supports techniques for configuring and triggering enhanced measurements in an idle or inactive state according to one or more aspects of the present disclosure. The communication timeline 600 may implement or be implemented by aspects of the wireless communications system 100 or the wireless communications system 200. For example, the communication timeline 300 may be implemented by a UE 115 or a network entity 105, as described with reference to FIGS. 1 and 2. The communication timeline 600 illustrates various RRC state transitions, measurement periods, and random access operations associated with an FR2 enhanced measurement scheme. In the example of FIG. 6, a network entity may provide a UE with measurement information 610 (such as the measurement configuration 205 described with reference to FIG. 2) via a unicast message or a broadcast message.

As described herein with reference to FIGS. 1 through 5, a UE may obtain an indication of a measurement configuration for FR2 enhanced measurements 415. For example, a network entity may provide the UE with following measurement information 610: candidate target FR2 frequencies for CA/DC; cell ID(s) for each target frequency; and an SSB burst (e.g., time-domain SSB position) for each target cell. The SSB burst for each target cell may be configured by the parameters ssb-PositionsInBurst>longBitmap (e.g., with a bit string size of 64).

The network may provide the measurement information 610 to the UE via either a unicast signal (e.g., an RRC reconfiguration message 605) or a broadcast signal (e.g., a SIB). The measurement information 610 provided by the network may improve the performance of the UE by enabling the UE to save energy and perform cell search and/or detection with reduced latency. Some aspects of the measurement configuration may overlap with other configurations of the UE, such as a configuration used for RRC IDLE/INACTIVE measurements. However, the FR2 enhanced measurements 620 may be independent (e.g., separate) from other IDLE/INACTIVE measurements performed by the UE.

In accordance with the techniques described herein, the UE may receive an indication of a measurement configuration (e.g., the measurement information 610) to use for the FR2 enhanced measurements 620. The measurement configuration may indicate parameters (e.g., cell IDs, SSB locations) associated with one or more target frequencies in FR2. Thereafter, when the UE is in an RRC idle or inactive state, the UE may perform measurements of the one or more target frequencies in accordance with the measurement configuration. In some examples, the MO/MT call 615 may trigger the FR2 enhanced measurements 620. Accordingly, the UE may transmit a measurement report 625 associated with the FR2 enhanced measurements 620 of the one or more target frequencies. The UE may transmit the measurement report 625 to the network after transitioning from the RRC idle or inactive mode to an RRC connected mode.

Aspects of the communication timeline 600 may be implemented to realize one or more of the following advantages. The techniques described with reference to FIG. 6 may improve the efficiency of IDLE/INACTIVE measurements and reduce the delay associated with setting up an SCell and/or SCG for CA and/or DC in FR2. More specifically, providing a UE with a measurement configuration to use for FR2 enhanced measurements 620 in an IDLE/INACTIVE mode may reduce the amount of time and power the UE spends on cell search and selection, which may enable the UE to identify and measure candidate SCells and/or SCGs with reduced latency and greater efficiency. Also, if traffic demand is relatively low (e.g., below a data volume threshold), the UE may refrain from performing FR2 enhanced measurements 620, thereby avoiding extraneous power consumption and/or processing overhead.

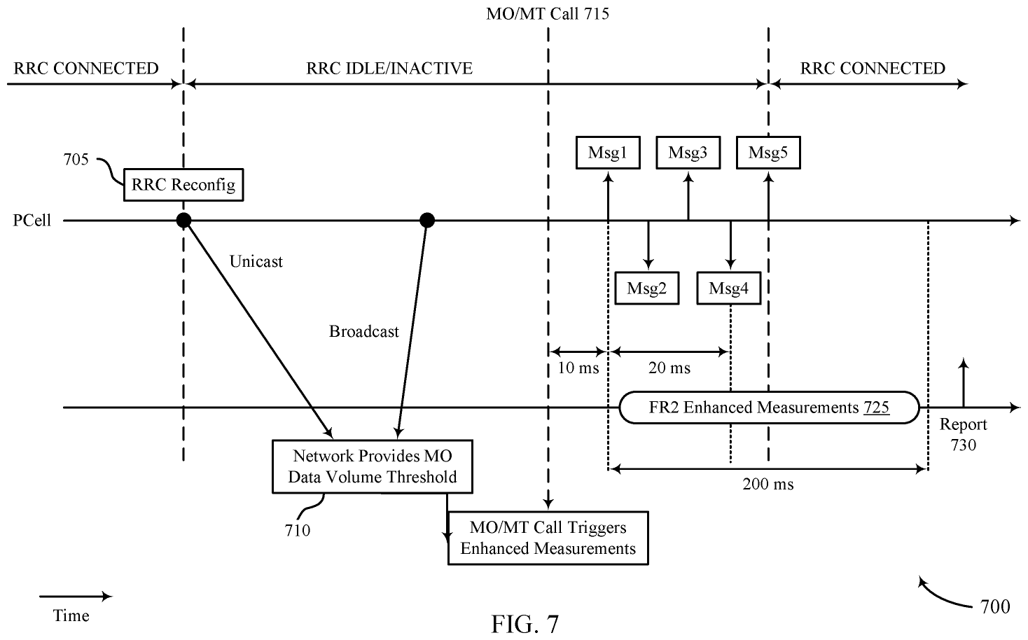

FIG. 7 illustrates an example of a communication timeline 700 that supports techniques for configuring and triggering enhanced measurements in an idle or inactive state according to one or more aspects of the present disclosure. The communication timeline 700 may implement or be implemented by aspects of the wireless communications system 100 or the wireless communications system 200. For example, the communication timeline 700 may be implemented by a UE 115 or a network entity 105, as described with reference to FIGS. 1 and 2. The communication timeline 700 illustrates various RRC state transitions, measurement periods, and random access operations associated with an FR2 enhanced measurement scheme. In the example of FIG. 7, a network entity may provide a UE with an indication of a MO data volume threshold 710, above which the UE may automatically trigger and report FR2 enhanced measurements 725.

As described herein with reference to FIGS. 1 through 6, an MO/MT call 715 may be used to trigger FR2 enhanced measurements 725 for a UE in an RRC IDLE/INACTIVE mode. In some examples, a network entity may trigger the FR2 enhanced measurements 725 via an MT call based on traffic demand. In other examples, the UE may trigger the FR2 enhanced measurements 725 via an MO call. Although the UE may be configured to perform the FR2 enhanced measurements 725, the UE may determine not to activate/use FR2 CA/DC, depending on traffic demands. In such examples, performing the FR2 enhanced measurements 725 may result in extraneous power consumption and processing overhead.

Aspects of the present disclosure may support two mechanisms of triggering the FR2 enhanced measurements 725. In an example of the first mechanism (an MT-based measurement trigger), the network may use an MT call to initiate the FR2 enhanced measurements 725. The network may trigger the MT call based on a volume of data to be communicated between the network and the UE. If the volume of data is relatively high and the UE supports CA/DC, using CA/DC may enable the UE to attain higher throughput levels (e.g., by communicating data via multiple cells). In some examples, the network may trigger the FR2 enhanced measurements 725 via a paging message.

In an example of the second mechanism, the UE may initiate the FR2enhanced measurements 725 via an MO call. In some examples, the network may determine not to set up or otherwise activate CA/DC if a data volume of the UE is less than a threshold. The network may provide the UE with details about the threshold of MO data such that the UE may autonomously determine whether to perform the FR2 enhanced measurements 725. In such examples, the UE may initiate the FR2 enhanced measurements 725 if the MO data volume of the UE is larger than a threshold. In some implementations, different thresholds may be configured based on whether the UE supports per-frequency range (FR) measurement gaps (MG) or not, since the efficiency of FR1+FR2 may be different.

In accordance with the techniques described herein, the UE may receive an indication of a measurement configuration to use for the FR2 enhanced measurements 725. The measurement configuration may indicate parameters (e.g., cell IDs, SSB locations) associated with one or more target frequencies in FR2. Thereafter, when the UE is in an RRC idle or inactive state, the UE may perform measurements of the one or more target frequencies in accordance with the measurement configuration. In some examples, the MO/MT call 715 may trigger the FR2 enhanced measurements 725. Accordingly, the UE may transmit a measurement report 730 associated with the FR2 enhanced measurements 725 of the one or more target frequencies. The UE may transmit the measurement report 730 to the network after transitioning from the RRC idle or inactive mode to an RRC connected mode.

Aspects of the communication timeline 700 may be implemented to realize one or more of the following advantages. The techniques described with reference to FIG. 7 may improve the efficiency of IDLE/INACTIVE measurements and reduce the delay associated with setting up an SCell/SCG for CA/DC in FR2. More specifically, providing a UE with a measurement configuration to use for FR2 enhanced measurements 725 in an IDLE/INACTIVE mode may reduce the amount of time and power the UE spends on cell search and selection, which may enable the UE to identify and measure candidate SCells/SCGs with reduced latency and greater efficiency. Also, if traffic demand is relatively low (e.g., below a data volume threshold), the UE may refrain from performing FR2 enhanced measurements 725, thereby avoiding extraneous power consumption and/or processing overhead.

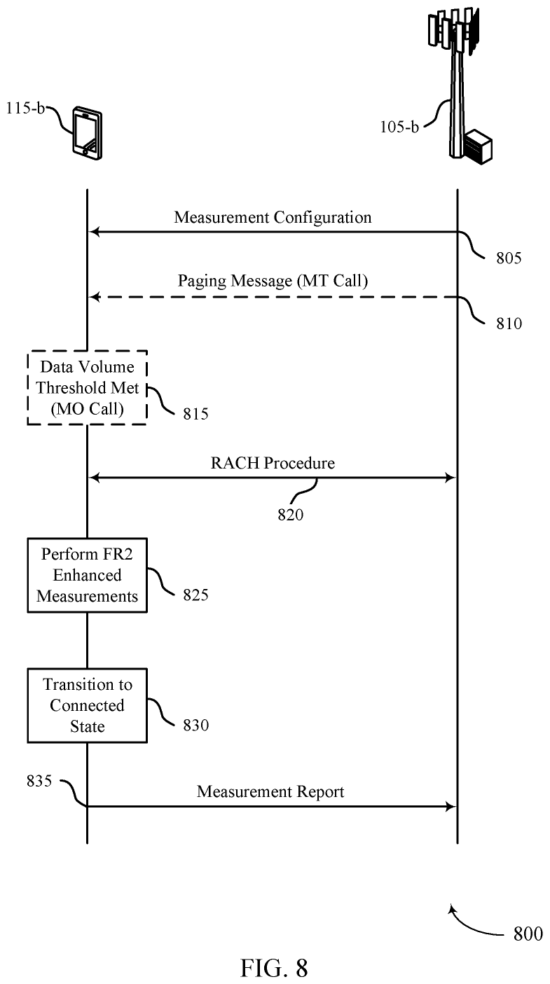

FIG. 8 illustrates an example of a process flow 800 that supports techniques for configuring and triggering enhanced measurements in an idle or inactive state according to one or more aspects of the present disclosure. The process flow 800 may implement or be implemented by aspects of any of the wireless communications systems, communication timelines, or resource diagrams described with reference to FIGS. 1 through 7. For example, the process flow 800 includes a UE 115-b and a network entity 105-b, which may be examples of corresponding devices described with reference to FIGS. 1 and 2. In the following description of the process flow 800, operations between the UE 115-a and the network entity 105-b may be omitted, added, or performed in a different order (with respect to the exemplary order shown).

At 805, the UE 115-b may receive an indication of a measurement configuration (e.g., the measurement configuration 205 described with reference to FIG. 2) from the network entity 105-b. The measurement configuration may indicate respective cell IDs for one or more target frequencies in a first frequency range (e.g., FR2), respective SSB resource locations for each of the one or more target frequencies, or both. In some examples (e.g., if the UE 115-b is in an RRC CONNECTED state), the UE 115-b may receive the indication of the measurement configuration via a unicast message (e.g., the RRC reconfiguration message 705 described with reference to FIG. 7). In other examples (e.g., if the UE 115-b is in an RRC IDLE/INACTIVE state), the UE 115-b may receive the indication of the measurement configuration via a broadcast message, such as a SIB.

In some examples, the network entity 105-b may trigger FR2 enhanced measurements (e.g., the FR2 enhanced measurements 725 described with reference to FIG. 7) via an MT call at 810. The network entity 105-b may indicate the MT call via a paging message. In other examples, the UE 115-b may trigger the FR2 enhanced measurements via an MO call at 815. For example, if the network provides the UE 115-b with an indication of a MO data volume threshold and a MO data volume of the UE 115-b exceeds the MO data volume threshold, the UE 115-b may trigger the FR2 enhanced measurements via an MO call.

At 820, the UE 115-b may initiate a RACH procedure with the network entity 105-b in response to the MO/MT call. For example, the UE 115-b may transmit a Msg1 to the network entity 105-b, receive a Msg2 from the network entity 105-b in response to the Msg1, transmit a Msg3 to the network entity 105-b in response to the Msg2, receive a Msg4 (e.g., an RRC setup or resume request message) from the network entity in response to the Msg3, and transmit a Msg5 (e.g., an RRC setup or resume complete message) to the network entity 105-b in response to the Msg4.

At 825, the UE 115-b may perform the FR2 enhanced measurements in accordance with the measurement configuration received from the network entity 105-b. For example, the UE 115-b may receive and measure signals (e.g., system information, SSBs) via the one or more target frequencies (also referred to herein as candidate cells) indicated by the measurement configuration. In some implementations, the UE 115-b may begin the FR2 enhanced measurements after transmitting the Msg1 to the network entity 105-b during the RACH procedure at 825. The duration for which the UE 115-b performs the FR2 enhanced measurements may, in some examples, be greater than or equal to 200 ms.

At 830, the UE 115-b may transition to an RRC CONNECTED state after successfully completing the RACH procedure at 820. At 835, the UE 115-b may report the FR2 enhanced measurements to the network entity 105-b. In some examples, the network entity 105-b may use the FR2 enhanced measurements from the UE 115-b to set up FR2 CA/DC for the UE 115-b.

Aspects of the process flow 800 may be implemented to realize one or more of the following advantages. The techniques described with reference to FIG. 8 may improve the efficiency of IDLE/INACTIVE measurements at the UE 115-b and reduce the delay associated with setting up an SCell/SCG for CA/DC in FR2. More specifically, providing the UE 115-b with a measurement configuration to use for FR2 enhanced measurements in an IDLE/INACTIVE mode may reduce the amount of time and power the UE 115-b spends on cell search and selection, which may enable the UE 115-b to identify and measure candidate SCells/SCGs with reduced latency and greater efficiency. Also, if traffic demand is relatively low (e.g., below a data volume threshold), the UE 115-b may refrain from performing FR2 enhanced measurements, thereby avoiding extraneous power consumption and/or processing overhead.

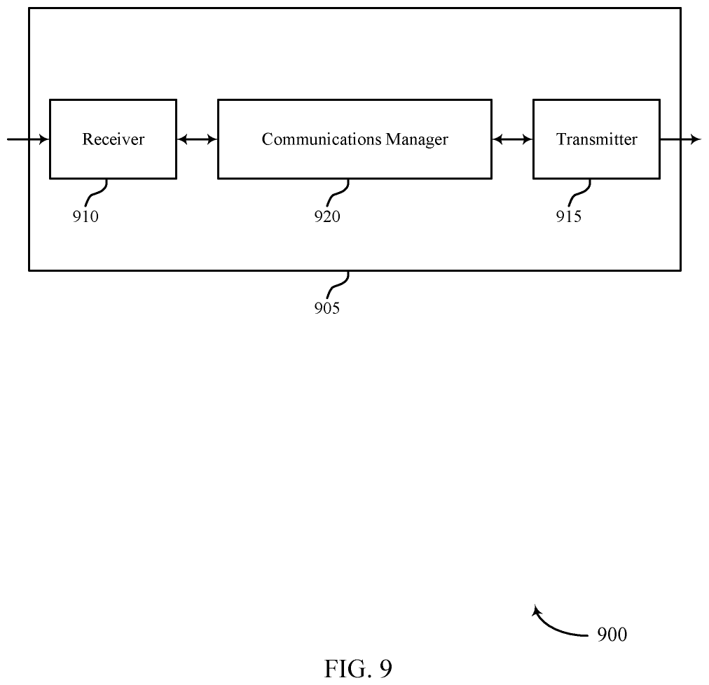

FIG. 9 illustrates a block diagram 900 of a device 905 that supports techniques for configuring and triggering enhanced measurements in an idle or inactive state according to one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for configuring and triggering enhanced measurements in an idle or inactive state). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for configuring and triggering enhanced measurements in an idle or inactive state). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for configuring and triggering enhanced measurements in an idle or inactive state as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples disclosed herein. For example, the communications manager 920 may be configured as or otherwise support a means for receiving an indication of an enhanced measurement configuration that includes information associated with one or more target frequencies in a first frequency range. The communications manager 920 may be configured as or otherwise support a means for performing measurements of the one or more target frequencies in the first frequency range in accordance with the enhanced measurement configuration while the UE is in an idle or inactive state. The communications manager 920 may be configured as or otherwise support a means for transmitting an indication of a measurement report associated with the measurements of the one or more target frequencies in the first frequency range based on transitioning from the idle or inactive state to a connected state.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

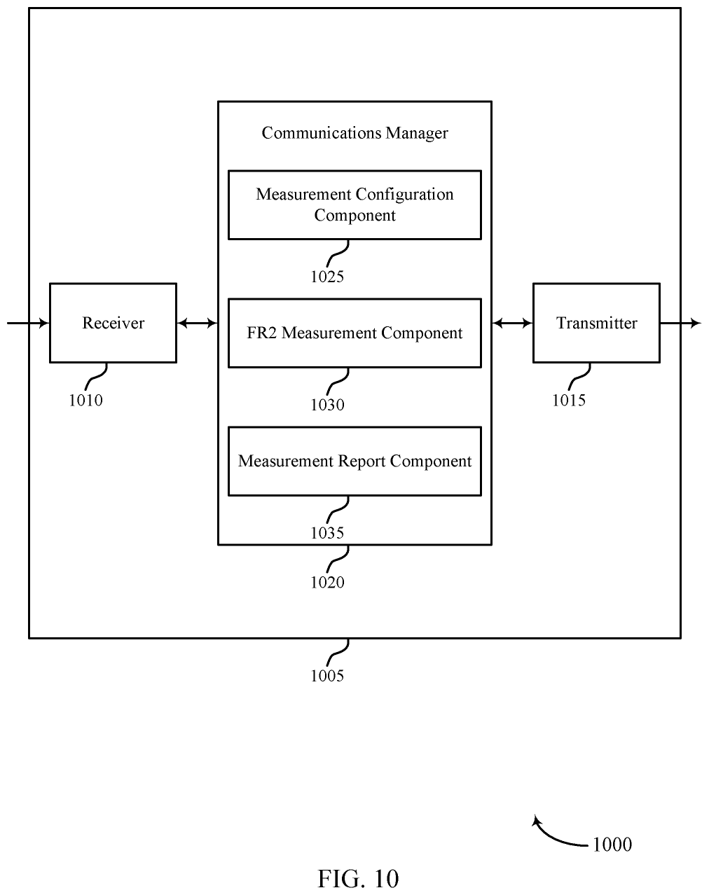

FIG. 10 illustrates a block diagram 1000 of a device 1005 that supports techniques for configuring and triggering enhanced measurements in an idle or inactive state according to one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for configuring and triggering enhanced measurements in an idle or inactive state). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for configuring and triggering enhanced measurements in an idle or inactive state). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for configuring and triggering enhanced measurements in an idle or inactive state as described herein. For example, the communications manager 1020 may include a measurement configuration component 1025, an FR2 measurement component 1030, a measurement report component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a UE in accordance with examples disclosed herein. The measurement configuration component 1025 may be configured as or otherwise support a means for receiving an indication of an enhanced measurement configuration that includes information associated with one or more target frequencies in a first frequency range. The FR2 measurement component 1030 may be configured as or otherwise support a means for performing measurements of the one or more target frequencies in the first frequency range in accordance with the enhanced measurement configuration while the UE is in an idle or inactive state. The measurement report component 1035 may be configured as or otherwise support a means for transmitting an indication of a measurement report associated with the measurements of the one or more target frequencies in the first frequency range based on transitioning from the idle or inactive state to a connected state.

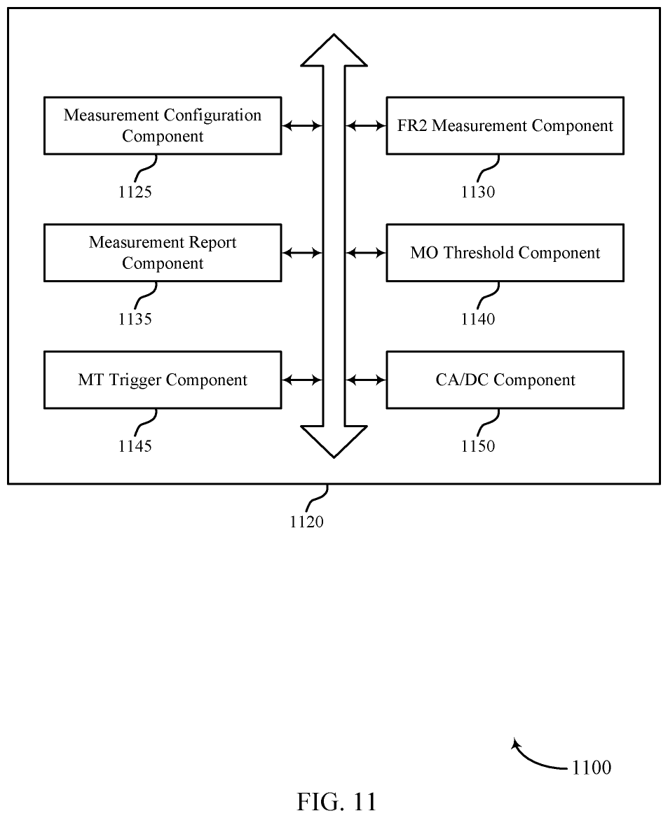

FIG. 11 illustrates a block diagram 1100 of a communications manager 1120 that supports techniques for configuring and triggering enhanced measurements in an idle or inactive state according to one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for configuring and triggering enhanced measurements in an idle or inactive state as described herein. For example, the communications manager 1120 may include a measurement configuration component 1125, an FR2 measurement component 1130, a measurement report component 1135, a MO threshold component 1140, an MT trigger component 1145, a CA/DC component 1150, or any combination thereof. Each of these components may communicate, directly or indirectly, with one another (e.g., via one or more buses).

The communications manager 1120 may support wireless communication at a UE in accordance with examples disclosed herein. The measurement configuration component 1125 may be configured as or otherwise support a means for receiving an indication of an enhanced measurement configuration that includes information associated with one or more target frequencies in a first frequency range. The FR2 measurement component 1130 may be configured as or otherwise support a means for performing measurements of the one or more target frequencies in the first frequency range in accordance with the enhanced measurement configuration while the UE is in an idle or inactive state. The measurement report component 1135 may be configured as or otherwise support a means for transmitting an indication of a measurement report associated with the measurements of the one or more target frequencies in the first frequency range based on transitioning from the idle or inactive state to a connected state.

In some examples, to support receiving the indication of the enhanced measurement configuration, the measurement configuration component 1125 may be configured as or otherwise support a means for receiving, while the UE is in the connected state, an RRC reconfiguration message that indicates respective cell IDs for each of the one or more target frequencies in the first frequency range, respective SSB resource locations for each of the one or more target frequencies, or both.

In some examples, to support performing the measurements of the one or more target frequencies, the FR2 measurement component 1130 may be configured as or otherwise support a means for performing one or more of a cell detection procedure, a cell search procedure, or a cell selection procedure based on the information provided in the enhanced measurement configuration.

In some examples, to support receiving the indication of the enhanced measurement configuration, the measurement configuration component 1125 may be configured as or otherwise support a means for receiving, while the UE is in the idle or inactive state, a SIB that indicates respective cell IDs for each of the one or more target frequencies in the first frequency range, respective SSB resource locations for each of the one or more target frequencies, or both.

In some examples, to support receiving the indication of the enhanced measurement configuration, the measurement configuration component 1125 may be configured as or otherwise support a means for receiving, via a PCell, a unicast message or a broadcast message that indicates the enhanced measurement configuration.

In some examples, the MO threshold component 1140 may be configured as or otherwise support a means for receiving an indication of a MO data volume threshold, where performing the measurements of the one or more target frequencies in the first frequency range is based on the UE satisfying the MO data volume threshold. In some examples, the MO data volume threshold depends on whether the UE supports per-FR MGs.

In some examples, the MT trigger component 1145 may be configured as or otherwise support a means for receiving an indication of a MT enhanced measurement trigger, where performing the measurements of the one or more target frequencies in the first frequency range is based on the MT enhanced measurement trigger.

In some examples, the MT enhanced measurement trigger is indicated via a paging message. In some examples, to support receiving the indication of the MT enhanced measurement trigger, the MT trigger component 1145 may be configured as or otherwise support a means for receiving the indication of MT enhanced measurement trigger based on a volume of data to be communicated between the UE and a network entity.

In some examples, the CA/DC component 1150 may be configured as or otherwise support a means for communicating with a network entity via a PCell and at least one SCell associated with the first frequency range in accordance with a CA or DC mode based on transmitting the measurement report.

In some examples, the MO threshold component 1140 may be configured as or otherwise support a means for determining whether to initiate the measurements of the one or more target frequencies in the first frequency range based on a MO data volume of the UE. In some examples, the first frequency range includes frequencies between 24.25 GHz and 71.0 GHz. In some examples, the one or more target frequencies include candidate frequencies for CA or DC in FR2.

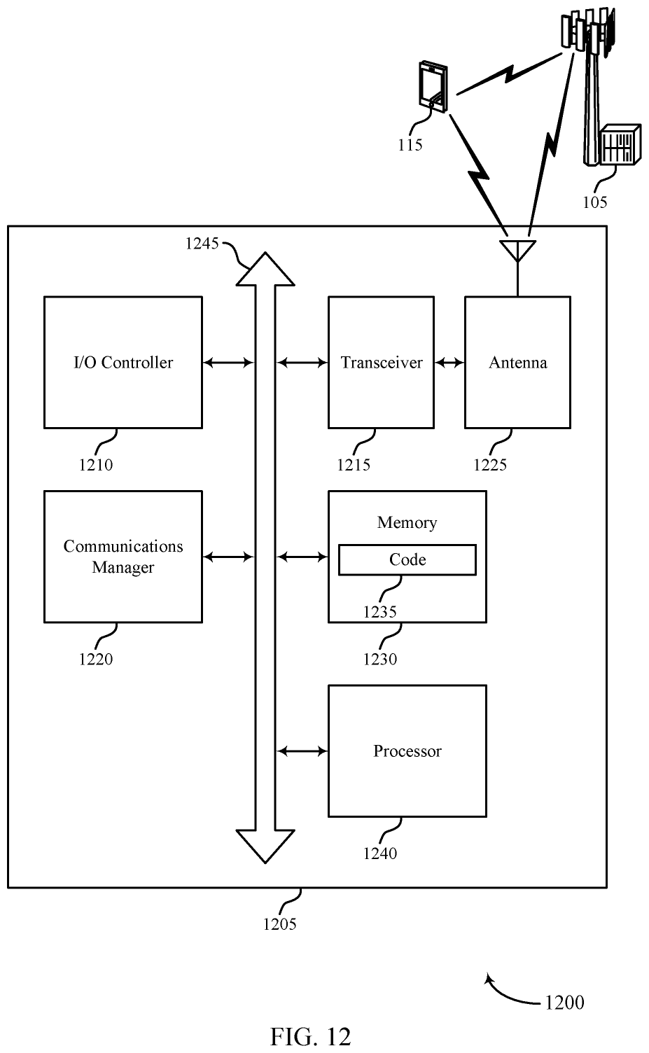

FIG. 12 illustrates a diagram of a system 1200 including a device 1205 that supports techniques for configuring and triggering enhanced measurements in an idle or inactive state according to one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for configuring and triggering enhanced measurements in an idle or inactive state). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples disclosed herein. For example, the communications manager 1220 may be configured as or otherwise support a means for receiving an indication of an enhanced measurement configuration that includes information associated with one or more target frequencies in a first frequency range. The communications manager 1220 may be configured as or otherwise support a means for performing measurements of the one or more target frequencies in the first frequency range in accordance with the enhanced measurement configuration while the UE is in an idle or inactive state. The communications manager 1220 may be configured as or otherwise support a means for transmitting an indication of a measurement report associated with the measurements of the one or more target frequencies in the first frequency range based on transitioning from the idle or inactive state to a connected state.

By including or configuring the communications manager 1220 in accordance with examples as described herein, the device 1205 may support techniques for improving the efficiency of IDLE/INACTIVE measurements and reduce the delay associated with setting up an SCell/SCG for CA/DC in FR2. More specifically, providing the device 1205 with a measurement configuration to use for FR2 enhanced measurements in an IDLE/INACTIVE mode may reduce the amount of time and power the device 1205 spends on cell search and selection, which may enable the device 1205 to identify and measure candidate SCells/SCGs with reduced latency and greater efficiency. Also, if traffic demand is relatively low (for example, below a data volume threshold), the device 1205 may refrain from performing FR2 enhanced measurements, resulting in greater power savings at the device 1205.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for configuring and triggering enhanced measurements in an idle or inactive state as described herein, or the processor 1240 and the memory 1230 may be otherwise configured to perform or support such operations.

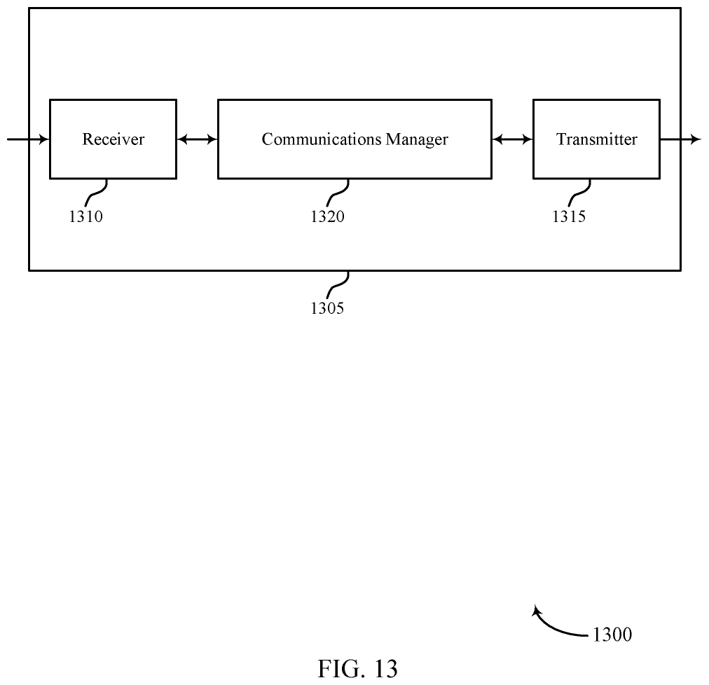

FIG. 13 illustrates a block diagram 1300 of a device 1305 that supports techniques for configuring and triggering enhanced measurements in an idle or inactive state according to one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of techniques for configuring and triggering enhanced measurements in an idle or inactive state as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples disclosed herein. For example, the communications manager 1320 may be configured as or otherwise support a means for outputting an indication of an enhanced measurement configuration that includes information associated with one or more target frequencies in a first frequency range. The communications manager 1320 may be configured as or otherwise support a means for obtaining an indication of a measurement report from a UE in accordance with the enhanced measurement configuration based on performing a random access procedure with the UE, where the measurement report is associated with measurements of the one or more target frequencies in the first frequency range.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced processing, reduced power consumption, and more efficient utilization of communication resources.

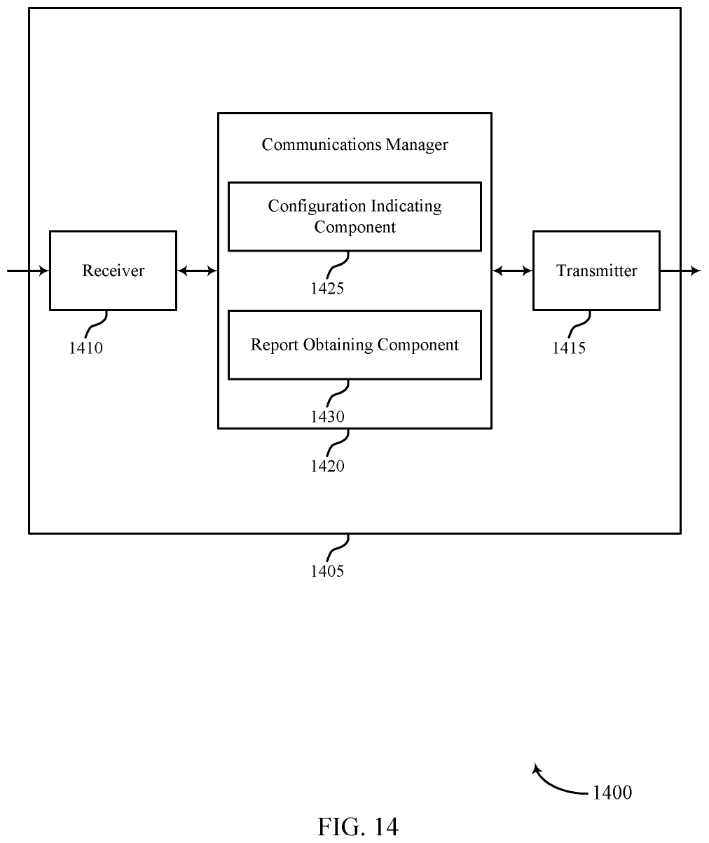

FIG. 14 illustrates a block diagram 1400 of a device 1405 that supports techniques for configuring and triggering enhanced measurements in an idle or inactive state according to one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of techniques for configuring and triggering enhanced measurements in an idle or inactive state as described herein. For example, the communications manager 1420 may include a configuration indicating component 1425 a report obtaining component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communication at a network entity in accordance with examples disclosed herein. The configuration indicating component 1425 may be configured as or otherwise support a means for outputting an indication of an enhanced measurement configuration that includes information associated with one or more target frequencies in a first frequency range. The report obtaining component 1430 may be configured as or otherwise support a means for obtaining an indication of a measurement report from a UE in accordance with the enhanced measurement configuration based on performing a random access procedure with the UE, where the measurement report is associated with measurements of the one or more target frequencies in the first frequency range.

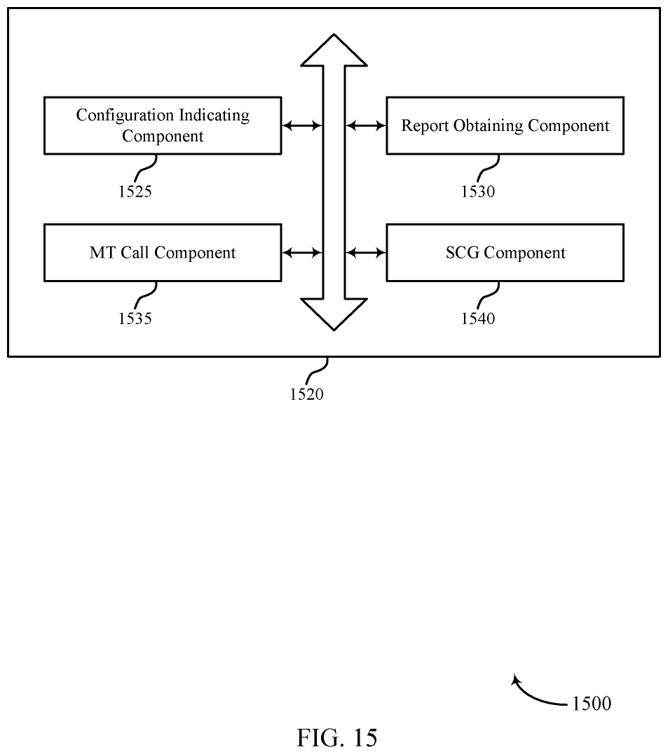

FIG. 15 illustrates a block diagram 1500 of a communications manager 1520 that supports techniques for configuring and triggering enhanced measurements in an idle or inactive state according to one or more aspects of the present disclosure. The communications manager 1520 may be an example of aspects of a communications manager 1320, a communications manager 1420, or both, as described herein. The communications manager 1520, or various components thereof, may be an example of means for performing various aspects of techniques for configuring and triggering enhanced measurements in an idle or inactive state as described herein. For example, the communications manager 1520 may include a configuration indicating component 1525, a report obtaining component 1530, an MT call component 1535, an SCG component 1540, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communication at a network entity in accordance with examples disclosed herein. The configuration indicating component 1525 may be configured as or otherwise support a means for outputting an indication of an enhanced measurement configuration that includes information associated with one or more target frequencies in a first frequency range. The report obtaining component 1530 may be configured as or otherwise support a means for obtaining an indication of a measurement report from a UE in accordance with the enhanced measurement configuration based on performing a random access procedure with the UE, where the measurement report is associated with measurements of the one or more target frequencies in the first frequency range.

In some examples, to support outputting the indication of the enhanced measurement configuration, the configuration indicating component 1525 may be configured as or otherwise support a means for outputting an RRC reconfiguration message that indicates respective cell IDs for each of the one or more target frequencies in the first frequency range, respective SSB resource locations for each of the one or more target frequencies, or both.

In some examples, to support outputting the indication of the enhanced measurement configuration, the configuration indicating component 1525 may be configured as or otherwise support a means for outputting a SIB that indicates respective cell IDs for each of the one or more target frequencies in the first frequency range, respective SSB resource locations for each of the one or more target frequencies, or both.

In some examples, to support outputting the indication of the enhanced measurement configuration, the configuration indicating component 1525 may be configured as or otherwise support a means for outputting, via a PCell, a unicast message or a broadcast message that indicates the enhanced measurement configuration.

In some examples, the configuration indicating component 1525 may be configured as or otherwise support a means for outputting an indication of a MO data volume threshold, where obtaining the measurement report is based on the MO data volume threshold being satisfied.

In some examples, the MO data volume threshold depends on whether the UE supports per-FR MGs.

In some examples, the MT call component 1535 may be configured as or otherwise support a means for outputting an indication of a MT enhanced measurement trigger, where obtaining the measurement report is based on the MT enhanced measurement trigger. In some examples, the MT enhanced measurement trigger is indicated via a paging message.

In some examples, to support outputting the indication of the MT enhanced measurement trigger, the MT call component 1535 may be configured as or otherwise support a means for outputting the indication of MT enhanced measurement trigger based on a volume of data to be communicated between the UE and a network entity.

In some examples, the SCG component 1540 may be configured as or otherwise support a means for communicating with the UE via a PCell and at least one SCell associated with the first frequency range in accordance with a CA or DC mode based on obtaining the measurement report.

In some examples, the first frequency range includes frequencies between 24.25 GHz and 71.0 GHz. In some examples, the one or more target frequencies include candidate frequencies for CA or DC in FR2.

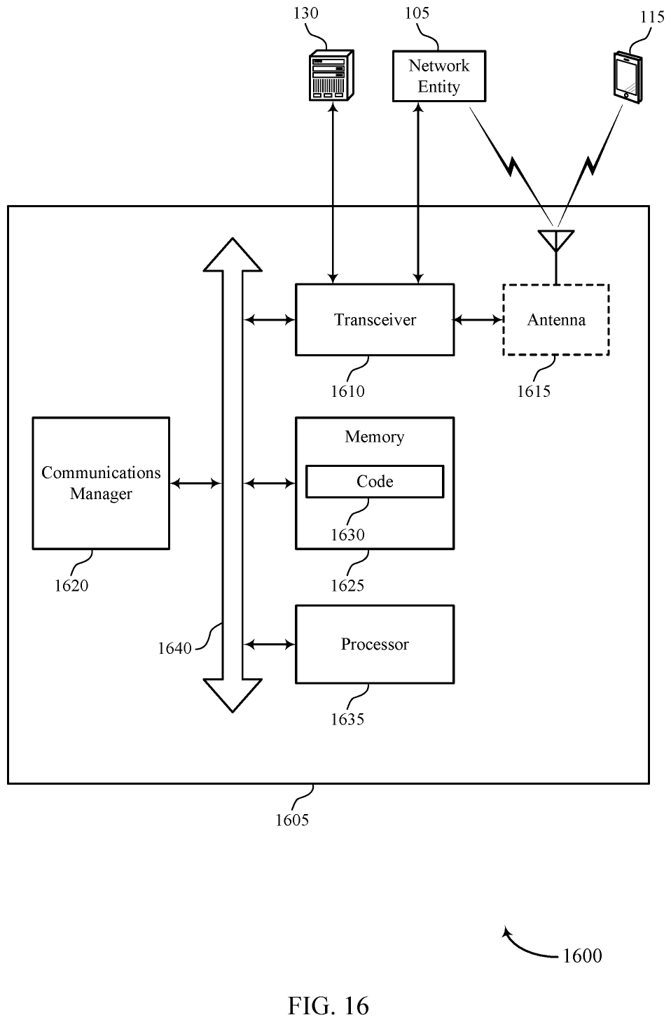

FIG. 16 illustrates a diagram of a system 1600 including a device 1605 that supports techniques for configuring and triggering enhanced measurements in an idle or inactive state according to one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals.

In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof.

In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting techniques for configuring and triggering enhanced measurements in an idle or inactive state). For example, the device 1605 or a component of the device 1605 may include a processor 1635 and memory 1625 coupled with the processor 1635, the processor 1635 and memory 1625 configured to perform various functions described herein.

The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system.

A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components.

For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem.

Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105, and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communication at a network entity in accordance with examples disclosed herein. For example, the communications manager 1620 may be configured as or otherwise support a means for outputting an indication of an enhanced measurement configuration that includes information associated with one or more target frequencies in a first frequency range. The communications manager 1620 may be configured as or otherwise support a means for obtaining an indication of a measurement report from a UE in accordance with the enhanced measurement configuration based on performing a random access procedure with the UE, where the measurement report is associated with measurements of the one or more target frequencies in the first frequency range.

By including or configuring the communications manager 1620 in accordance with examples as described herein, the device 1605 may support techniques for improving the efficiency of IDLE/INACTIVE measurements and reduce the delay associated with setting up an SCell/SCG for CA/DC in FR2. More specifically, providing a UE with a measurement configuration to use for FR2 enhanced measurements in an IDLE/INACTIVE mode may reduce the amount of time and power the UE spends on cell search and selection, which may enable the UE to identify and measure candidate SCells/SCGs with reduced latency and greater efficiency. Also, if traffic demand is relatively low (for example, below a data volume threshold), the device 1605 may refrain from triggering FR2 enhanced measurements, resulting in greater power savings at the UE.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of techniques for configuring and triggering enhanced measurements in an idle or inactive state as described herein, or the processor 1635 and the memory 1625 may be otherwise configured to perform or support such operations.

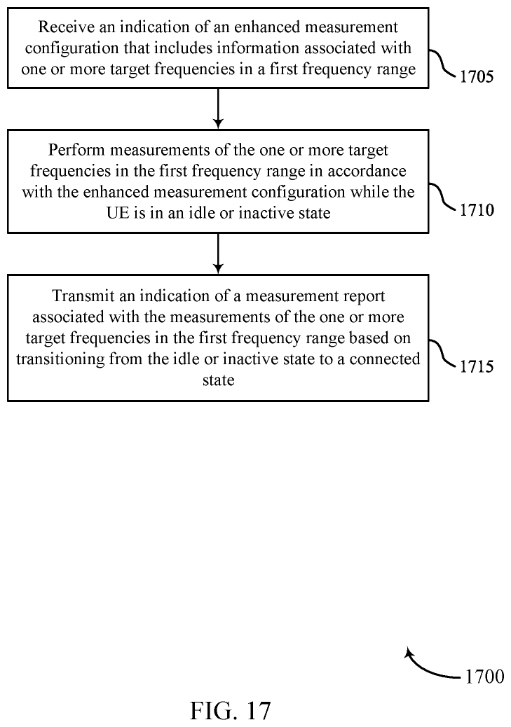

FIG. 17 illustrates a flowchart showing a method 1700 that supports techniques for configuring and triggering enhanced measurements in an idle or inactive state according to one or more aspects of the present disclosure. The operations of the method 1700 may be implemented by a UE or components thereof. For example, the operations of the method 1700 may be performed by a UE 115, as described with reference to FIGS. 1 through 12. In some examples, the UE may execute a set of instructions to control the functional elements of the UE to perform the described functions. Additionally, or alternatively, the UE may perform aspects of the described functions using special-purpose hardware.

At 1705, the UE may receive an indication of an enhanced measurement configuration that includes information associated with one or more target frequencies in a first frequency range. The operations of 1705 may be performed in accordance with examples disclosed herein. In some examples, aspects of the operations of 1705 may be performed by a measurement configuration component 1125, as described with reference to FIG. 11.

At 1710, the UE may perform measurements of the one or more target frequencies in the first frequency range in accordance with the enhanced measurement configuration while the UE is in an idle or inactive state. The operations of 1710 may be performed in accordance with examples disclosed herein. In some examples, aspects of the operations of 1710 may be performed by an FR2 measurement component 1130, as described with reference to FIG. 11.

At 1715, the UE may transmit an indication of a measurement report associated with the measurements of the one or more target frequencies in the first frequency range based on transitioning from the idle or inactive state to a connected state. The operations of 1715 may be performed in accordance with examples disclosed herein. In some examples, aspects of the operations of 1715 may be performed by a measurement report component 1135, as described with reference to FIG. 11.

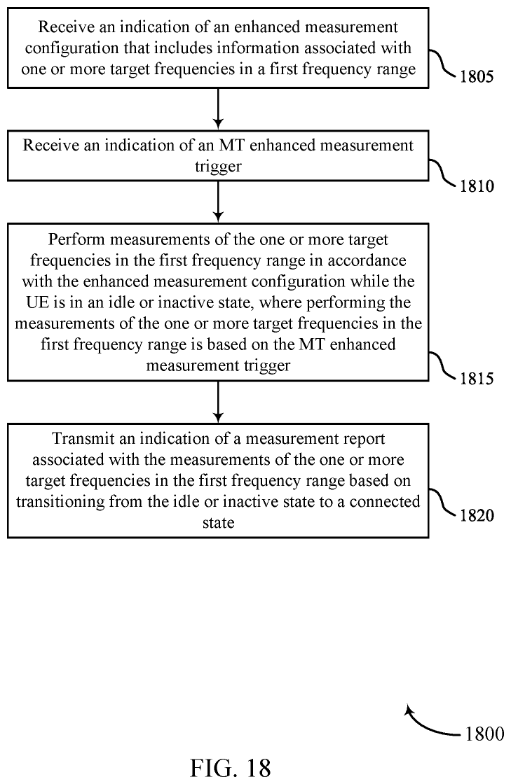

FIG. 18 illustrates a flowchart showing a method 1800 that supports techniques for configuring and triggering enhanced measurements in an idle or inactive state according to one or more aspects of the present disclosure. The operations of the method 1800 may be implemented by a UE or components thereof. For example, the operations of the method 1800 may be performed by a UE 115, as described with reference to FIGS. 1 through 12. In some examples, the UE may execute a set of instructions to control the functional elements of the UE to perform the described functions. Additionally, or alternatively, the UE may perform aspects of the described functions using special-purpose hardware.

At 1805, the UE may receive an indication of an enhanced measurement configuration that includes information associated with one or more target frequencies in a first frequency range. The operations of 1805 may be performed in accordance with examples disclosed herein. In some examples, aspects of the operations of 1805 may be performed by a measurement configuration component 1125, as described with reference to FIG. 11.

At 1810, the UE may receive an indication of an MT enhanced measurement trigger. The operations of 1810 may be performed in accordance with examples disclosed herein. In some examples, aspects of the operations of 1810 may be performed by an MT trigger component 1145, as described with reference to FIG. 11.

At 1815, the UE may perform measurements of the one or more target frequencies in the first frequency range in accordance with the enhanced measurement configuration while the UE is in an idle or inactive state, where performing the measurements of the one or more target frequencies in the first frequency range is based on the MT enhanced measurement trigger. The operations of 1815 may be performed in accordance with examples disclosed herein. In some examples, aspects of the operations of 1815 may be performed by an FR2 measurement component 1130, as described with reference to FIG. 11.

At 1820, the UE may transmit an indication of a measurement report associated with the measurements of the one or more target frequencies in the first frequency range based on transitioning from the idle or inactive state to a connected state. The operations of 1820 may be performed in accordance with examples disclosed herein. In some examples, aspects of the operations of 1820 may be performed by a measurement report component 1135, as described with reference to FIG. 11.

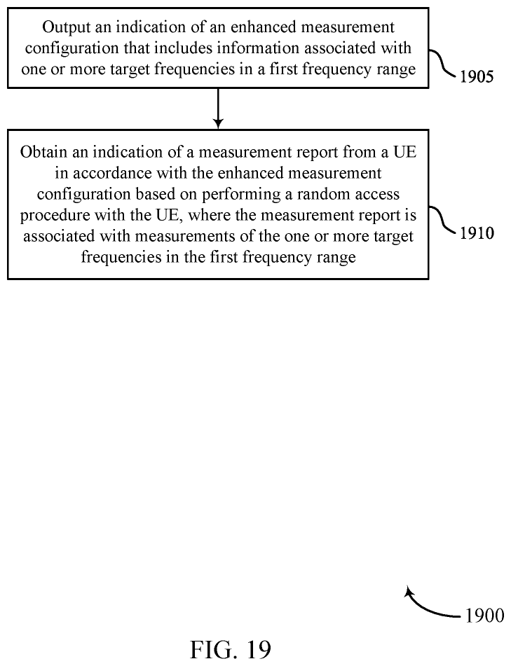

FIG. 19 illustrates a flowchart showing a method 1900 that supports techniques for configuring and triggering enhanced measurements in an idle or inactive state according to one or more aspects of the present disclosure. The operations of the method 1900 may be implemented by a network entity or components thereof. For example, the operations of the method 1900 may be performed by a network entity 105, as described with reference to FIGS. 1 through 8 and 13 through 16. In some examples, the network entity may execute a set of instructions to control the functional elements of the network entity to perform the described functions. Additionally, or alternatively, the network entity may perform aspects of the described functions using special-purpose hardware.

At 1905, the network entity may output an indication of an enhanced measurement configuration that includes information associated with one or more target frequencies in a first frequency range. The operations of 1905 may be performed in accordance with examples disclosed herein. In some examples, aspects of the operations of 1905 may be performed by a configuration indicating component 1525, as described with reference to FIG. 15.

At 1910, the network entity may obtain an indication of a measurement report from a UE in accordance with the enhanced measurement configuration based on performing a random access procedure with the UE, where the measurement report is associated with measurements of the one or more target frequencies in the first frequency range. The operations of 1910 may be performed in accordance with examples disclosed herein. In some examples, aspects of the operations of 1910 may be performed by a report obtaining component 1530, as described with reference to FIG. 15.

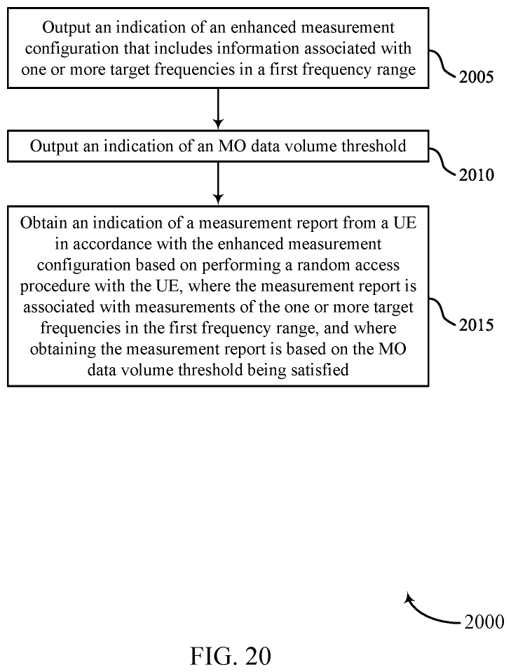

FIG. 20 illustrates a flowchart showing a method 2000 that supports techniques for configuring and triggering enhanced measurements in an idle or inactive state according to one or more aspects of the present disclosure. The operations of the method 2000 may be implemented by a network entity or components thereof. For example, the operations of the method 2000 may be performed by a network entity 105, as described with reference to FIGS. 1 through 8 and 13 through 16. In some examples, the network entity may execute a set of instructions to control the functional elements of the network entity to perform the described functions. Additionally, or alternatively, the network entity may perform aspects of the described functions using special-purpose hardware.

At 2005, the network entity may output an indication of an enhanced measurement configuration that includes information associated with one or more target frequencies in a first frequency range. The operations of 2005 may be performed in accordance with examples disclosed herein. In some examples, aspects of the operations of 2005 may be performed by a configuration indicating component 1525, as described with reference to FIG. 15.

At 2010, the network entity may output an indication of an MO data volume threshold. The operations of 2010 may be performed in accordance with examples disclosed herein. In some examples, aspects of the operations of 2010 may be performed by a configuration indicating component 1525, as described with reference to FIG. 15.

At 2015, the network entity may obtain an indication of a measurement report from a UE in accordance with the enhanced measurement configuration based on performing a random access procedure with the UE, where the measurement report is associated with measurements of the one or more target frequencies in the first frequency range, and where obtaining the measurement report is based on the MO data volume threshold being satisfied. The operations of 2015 may be performed in accordance with examples disclosed herein. In some examples, aspects of the operations of 2015 may be performed by a report obtaining component 1530, as described with reference to FIG. 15.

The following aspects are given by way of illustration. Examples of the following aspects may be combined with examples or embodiments shown or discussed in relation to the figures or elsewhere herein.
Aspect 1: A method for wireless communication at a UE, comprising: receiving an indication of an enhanced measurement configuration that includes information associated with one or more target frequencies in a first frequency range; performing measurements of the one or more target frequencies in the first frequency range in accordance with the enhanced measurement configuration while the UE is in an idle or inactive state; and transmitting an indication of a measurement report associated with the measurements of the one or more target frequencies in the first frequency range based at least in part on transitioning from the idle or inactive state to a connected state.
Aspect 2: The method of aspect 1, wherein receiving the indication of the enhanced measurement configuration comprises: receiving, while the UE is in the connected state, an RRC reconfiguration message that indicates respective cell IDs for each of the one or more target frequencies in the first frequency range, respective SSB resource locations for each of the one or more target frequencies, or both.
Aspect 3: The method of aspect 1, wherein performing the measurements of the one or more target frequencies comprises: performing one or more of a cell detection procedure, a cell search procedure, or a cell selection procedure based at least in part on the information provided in the enhanced measurement configuration.
Aspect 4: The method of aspect 1, wherein receiving the indication of the enhanced measurement configuration comprises: receiving, while the UE is in the idle or inactive state, a SIB that indicates respective cell IDs for each of the one or more target frequencies in the first frequency range, respective SSB resource locations for each of the one or more target frequencies, or both.
Aspect 5: The method of any of aspects 1 through 4, wherein receiving the indication of the enhanced measurement configuration comprises: receiving, via a primary cell, a unicast message or a broadcast message that indicates the enhanced measurement configuration.
Aspect 6: The method of any of aspects 1 through 5, further comprising: receiving an indication of a MO data volume threshold, wherein performing the measurements of the one or more target frequencies in the first frequency range is based at least in part on the UE satisfying the MO data volume threshold.
Aspect 7: The method of aspect 6, wherein the MO data volume threshold depends on whether the UE supports per-FR MGs.
Aspect 8: The method of any of aspects 1 through 5, further comprising: receiving an indication of a MT enhanced measurement trigger, wherein performing the measurements of the one or more target frequencies in the first frequency range is based at least in part on the MT enhanced measurement trigger.
Aspect 9: The method of aspect 8, wherein the MT enhanced measurement trigger is indicated via a paging message.
Aspect 10: The method of any of aspects 8 through 9, wherein receiving the indication of the MT enhanced measurement trigger comprises: receiving the indication of MT enhanced measurement trigger based at least in part on a volume of data to be communicated between the UE and a network entity.
Aspect 11: The method of any of aspects 1 through 10, further comprising: communicating with a network entity via a primary cell and at least one secondary cell associated with the first frequency range in accordance with a CA or DC mode based at least in part on transmitting the measurement report.
Aspect 12: The method of any of aspects 1 through 5, further comprising: determining whether to initiate the measurements of the one or more target frequencies in the first frequency range based at least in part on a MO data volume of the UE.
Aspect 13: The method of any of aspects 1 through 12, wherein the first frequency range includes frequencies between 24.25 GHz and 71.0 GHz.
Aspect 14: The method of any of aspects 1 through 13, wherein the one or more target frequencies comprise candidate frequencies for CA or DC in FR2.
Aspect 15: A method for wireless communication at a network entity, comprising: outputting an indication of an enhanced measurement configuration that includes information associated with one or more target frequencies in a first frequency range; and obtaining an indication of a measurement report from a UE in accordance with the enhanced measurement configuration based at least in part on performing a random access procedure with the UE, wherein the measurement report is associated with measurements of the one or more target frequencies in the first frequency range.
Aspect 16: The method of aspect 15, wherein outputting the indication of the enhanced measurement configuration comprises: outputting an RRC reconfiguration message that indicates respective cell IDs for each of the one or more target frequencies in the first frequency range, respective SSB resource locations for each of the one or more target frequencies, or both.
Aspect 17: The method of aspect 15, wherein outputting the indication of the enhanced measurement configuration comprises: outputting a SIB that indicates respective cell IDs for each of the one or more target frequencies in the first frequency range, respective SSB resource locations for each of the one or more target frequencies, or both.
Aspect 18: The method of any of aspects 15 through 17, wherein outputting the indication of the enhanced measurement configuration comprises: outputting, via a primary cell, a unicast message or a broadcast message that indicates the enhanced measurement configuration.
Aspect 19: The method of any of aspects 15 through 18, further comprising: outputting an indication of a MO data volume threshold, wherein obtaining the measurement report is based at least in part on the MO data volume threshold being satisfied.
Aspect 20: The method of aspect 19, wherein the MO data volume threshold depends on whether the UE supports per-FR MGs.
Aspect 21: The method of any of aspects 15 through 18, further comprising: outputting an indication of a MT enhanced measurement trigger, wherein obtaining the measurement report is based at least in part on the MT enhanced measurement trigger.
Aspect 22: The method of aspect 21, wherein the MT enhanced measurement trigger is indicated via a paging message.
Aspect 23: The method of any of aspects 21 through 22, wherein outputting the indication of the MT enhanced measurement trigger comprises: outputting the indication of MT enhanced measurement trigger based at least in part on a volume of data to be communicated between the UE and a network entity.
Aspect 24: The method of any of aspects 15 through 23, further comprising: communicating with the UE via a primary cell and at least one secondary cell associated with the first frequency range in accordance with a CA or DC mode based at least in part on obtaining the measurement report.
Aspect 25: The method of any of aspects 15 through 24, wherein the first frequency range includes frequencies between 24.25 GHz and 71.0 GHz.
Aspect 26: The method of any of aspects 15 through 25, wherein the one or more target frequencies comprise candidate frequencies for CA or DC in FR2.
Aspect 27: A UE for wireless communication, comprising: one or more memories and one or more processors coupled with the one or more memories and operable to cause the UE to perform a method of any of aspects 1 through 14.
Aspect 28: An apparatus for wireless communication at a UE, comprising at least one means for performing a method of any of aspects 1 through 14.
Aspect 29: A non-transitory computer-readable medium storing code for wireless communication at a UE, the code comprising instructions executable by one or more processors to perform a method of any of aspects 1 through 14.
Aspect 30: A network entity for wireless communication, comprising: one or more memories and one or more processors coupled with the one or more memories and operable to cause the network entity to perform a method of any of aspects 15 through 26.
Aspect 31: An apparatus for wireless communication at a network entity, comprising at least one means for performing a method of any of aspects 15 through 26.
Aspect 32: A non-transitory computer-readable medium storing code for wireless communication at a network entity, the code comprising instructions executable by one or more processors to perform a method of any of aspects 15 through 26.

Examples of these aspects may be combined with aspects or embodiments disclosed in other implementations.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communications, comprising:
one or more memories storing computer-executable code; and
one or more processors coupled with the one or more memories and operable to execute the code to cause the UE to:
receive an indication of an enhanced measurement configuration that includes information associated with one or more target frequencies in a first frequency range;
perform measurements of the one or more target frequencies in the first frequency range in accordance with the enhanced measurement configuration while the UE is in an idle or inactive state; and
transmit an indication of a measurement report associated with the measurements of the one or more target frequencies in the first frequency range based at least in part on transitioning from the idle or inactive state to a connected state.

2. The UE of claim 1, wherein, to receive the indication of the enhanced measurement configuration, the one or more processors are further operable to execute the code to cause the UE to:
receive, while the UE is in the connected state, a radio resource control (RRC) reconfiguration message that indicates respective cell identifiers for each of the one or more target frequencies in the first frequency range, respective synchronization signal block (SSB) resource locations for each of the one or more target frequencies, or both.

3. The UE of claim 1, wherein, to perform the measurements of the one or more target frequencies, the one or more processors are further operable to execute the code to cause the UE to:
perform one or more of a cell detection procedure, a cell search procedure, or a cell selection procedure based at least in part on the information provided in the enhanced measurement configuration.

4. The UE of claim 1, wherein, to receive the indication of the enhanced measurement configuration, the one or more processors are further operable to execute the code to cause the UE to:
receive, while the UE is in the idle or inactive state, a system information block (SIB) that indicates respective cell identifiers for each of the one or more target frequencies in the first frequency range, respective synchronization signal block (SSB) resource locations for each of the one or more target frequencies, or both.

5. The UE of claim 1, wherein the one or more processors are further operable to execute the code to cause the UE to:
receive an indication of a mobile-originated (MO) data volume threshold, wherein performing the measurements of the one or more target frequencies in the first frequency range is based at least in part on the UE satisfying the MO data volume threshold.

6. The UE of claim 5, wherein the MO data volume threshold depends on whether the UE supports per-frequency range measurement gaps.

7. The UE of claim 1, wherein the one or more processors are further operable to execute the code to cause the UE to:
communicate with a network entity via a primary cell and at least one secondary cell associated with the first frequency range in accordance with a carrier aggregation (CA) or dual connectivity (DC) mode based at least in part on transmitting the measurement report.

8. The UE of claim 1, wherein the one or more processors are further operable to execute the code to cause the UE to:
determine whether to initiate the measurements of the one or more target frequencies in the first frequency range based at least in part on a mobile-originated (MO) data volume of the UE.

9. The UE of claim 1, wherein:
the one or more target frequencies comprise candidate frequencies for carrier aggregation (CA) or dual connectivity (DC) in Frequency Range 2 (FR2).

10. A network entity for wireless communications, comprising:
one or more memories storing computer-executable code; and
one or more processors coupled with the one or more memories and operable to execute the code to cause the network entity to:
output an indication of an enhanced measurement configuration that includes information associated with one or more target frequencies in a first frequency range; and
obtain an indication of a measurement report from a user equipment (UE) in accordance with the enhanced measurement configuration based at least in part on performing a random access procedure with the UE, wherein the measurement report is associated with measurements of the one or more target frequencies in the first frequency range.

11. The network entity of claim 10, wherein, to output the indication of the enhanced measurement configuration, the one or more processors are further operable to execute the code to cause the network entity to:
output a radio resource control (RRC) reconfiguration message that indicates respective cell identifiers for each of the one or more target frequencies in the first frequency range, respective synchronization signal block (SSB) resource locations for each of the one or more target frequencies, or both.

12. The network entity of claim 10, wherein, to output the indication of the enhanced measurement configuration, the one or more processors are further operable to execute the code to cause the network entity to:
output a system information block (SIB) that indicates respective cell identifiers for each of the one or more target frequencies in the first frequency range, respective synchronization signal block (SSB) resource locations for each of the one or more target frequencies, or both.

13. The network entity of claim 10, wherein the one or more processors are further operable to execute the code to cause the network entity to:
output an indication of a mobile-terminated (MT) enhanced measurement trigger, wherein obtaining the measurement report is based at least in part on the MT enhanced measurement trigger.

14. The network entity of claim 13, wherein the MT enhanced measurement trigger is indicated via a paging message.

15. The network entity of claim 13, wherein, to output the indication of the MT enhanced measurement trigger, the one or more processors are further operable to execute the code to execute the code to cause the network entity to:
output the indication of MT enhanced measurement trigger based at least in part on a volume of data to be communicated between the UE and a network entity.

16. The network entity of claim 10, wherein the one or more processors are further operable to execute the code to cause the network entity to:
communicate with the UE via a primary cell and at least one secondary cell associated with the first frequency range in accordance with a carrier aggregation (CA) or dual connectivity (DC) mode based at least in part on obtaining the measurement report.

17. The network entity of claim 10, wherein:
the first frequency range includes frequencies between 24.25 gigahertz (GHz) and 71.0 GHz.

18. The network entity of claim 10, wherein:
the one or more target frequencies comprise candidate frequencies for carrier aggregation (CA) or dual connectivity (DC) in Frequency Range 2 (FR2).

19. A method for wireless communication at a user equipment (UE), comprising:
receiving an indication of an enhanced measurement configuration that includes information associated with one or more target frequencies in a first frequency range;
performing measurements of the one or more target frequencies in the first frequency range in accordance with the enhanced measurement configuration while the UE is in an idle or inactive state; and
transmitting an indication of a measurement report associated with the measurements of the one or more target frequencies in the first frequency range based at least in part on transitioning from the idle or inactive state to a connected state.

20. The method of claim 19, wherein receiving the indication of the enhanced measurement configuration comprises:
receiving, while the UE is in the connected state, a radio resource control (RRC) reconfiguration message that indicates respective cell identifiers for each of the one or more target frequencies in the first frequency range, respective synchronization signal block (SSB) resource locations for each of the one or more target frequencies, or both.
